(19) United States
(12) Patent Application Publication
(10) Pub. No.: US 2026/0016737 A1
(43) Pub. Date: Jan. 15, 2026

(54) IMAGING APPARATUS

(71) Applicant: CANON KABUSHIKI KAISHA, Tokyo (JP)

(72) Inventor: JUNICHIRO IWAMATSU, Tokyo (JP)

(21) Appl. No.: 19/338,505

(22) Filed: Sep. 24, 2025

Related U.S. Application Data
(63) Continuation of application No. PCT/JP2024/007581, filed on Feb. 29, 2024.

(30) Foreign Application Priority Data
Apr. 11, 2023 (JP) 2023-064128

(51) Int. Cl. G03B 17/10; G03B 17/12; H04N 23/51; H04N 23/54

(52) U.S. Cl. CPC G03B 17/10; G03B 17/12; H04N 23/51; H04N 23/54; G03B 2217/002

(57) ABSTRACT

An imaging apparatus includes a lens barrel, a first holding member that holds the lens barrel via a first elastic member, a second holding member that holds the lens barrel via a second elastic member, the first elastic member disposed between the lens barrel and the first holding member, and the second elastic member disposed between the lens barrel and the second holding member. The second holding member is disposed, in an optical axis direction, on an opposite side to the first holding member with the lens barrel interposed therebetween, and the lens barrel is clamped by the first holding member and the second holding member via the first elastic member and the second elastic member.

### CROSS-REFERENCE TO RELATED APPLICATIONS

This application is a Continuation of International Patent Application No. PCT/JP2024/007581, filed Feb. 29, 2024, which claims the benefit of Japanese Patent Application No. 2023-064128, filed Apr. 11, 2023, both of which are hereby incorporated by reference herein in their entirety.

### BACKGROUND

### Field of the Technology

The present disclosure relates to holding a lens barrel in an imaging apparatus.

### Description of the Related Art

Conventionally, in an imaging apparatus including a lens barrel, it is typical to employ a configuration in which the lens barrel is fastened to the imaging apparatus body using screws as a means for supporting the lens barrel. However, when the lens barrel is fastened and fixed by screws, vibration and mechanical noise generated in the lens barrel propagate through the screws to a microphone that is provided in the imaging apparatus body and are collected as sound. Accordingly, there has been a need for a configuration that suppresses direct transmission of external force in the optical axis direction from the lens barrel to the apparatus body, and that suppresses mechanical noise from the lens barrel from being directly transmitted to a frame. For example, Japanese Patent Application Laid-Open No. 2012-215828 discloses a method of holding the lens barrel by sandwiching the lens barrel between a frame and a frame plate via a rubber cap.

However, in the conventional technology that is disclosed in Japanese Patent Application Laid-Open No. 2012-215828, it is necessary to individually insert rubber caps into a plurality of attachment portions that are provided both on the lens barrel and the frame, which reduces the ease of assembly.

### SUMMARY

The present disclosure is directed to provide an imaging apparatus that is easy to assemble and capable of reducing the propagation of vibrations that are generated in the lens barrel.

An imaging apparatus according to an aspect of the present disclosure comprises a lens barrel, a first holding member that holds the lens barrel via a first elastic member, a second holding member that holds the lens barrel via a second elastic member, the first elastic member disposed between the lens barrel and the first holding member, and the second elastic member disposed between the lens barrel and the second holding member. The second holding member is disposed, in an optical axis direction, on an opposite side to the first holding member with the lens barrel interposed therebetween, and the lens barrel is clamped by the first holding member and the second holding member via the first elastic member and the second elastic member.

Features of the present disclosure will become apparent from the following description of embodiments with reference to the attached drawings.

### BRIEF DESCRIPTION OF THE DRAWINGS

FIGS. 1A to 1C are explanatory views of an external appearance of a camera.

FIG. 2 is an explanatory view of a unit that constitutes the interior of the camera.

FIGS. 3A and 3B are explanatory views of the configuration of a lens barrel.

FIGS. 4A to 4D are explanatory views of a clamping structure of the lens barrel.

FIG. 5 is an explanatory view of a clamping structure of the lens barrel.

FIGS. 6A and 6B are diagrams illustrating the positional relation between a main base and a housing portion of a sensor holder.

### DESCRIPTION OF THE EMBODIMENTS

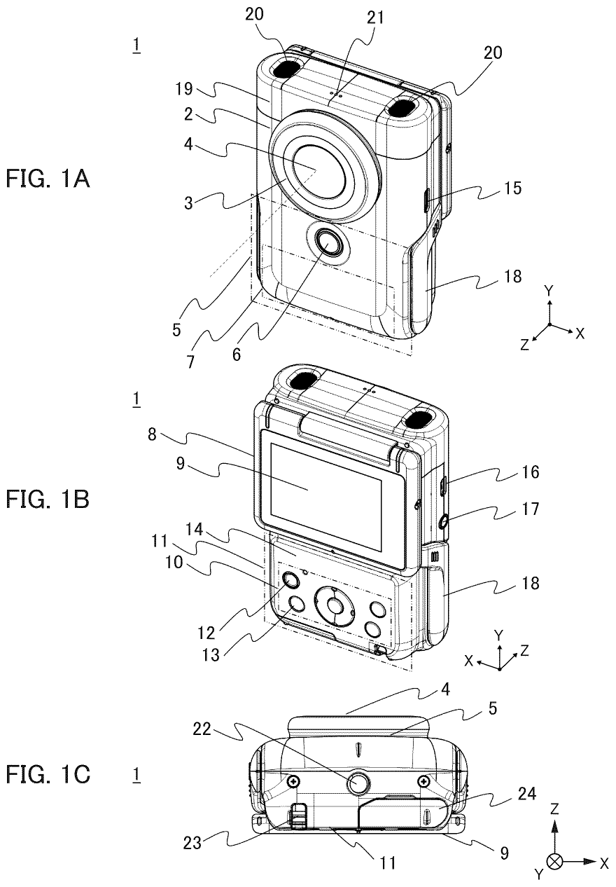

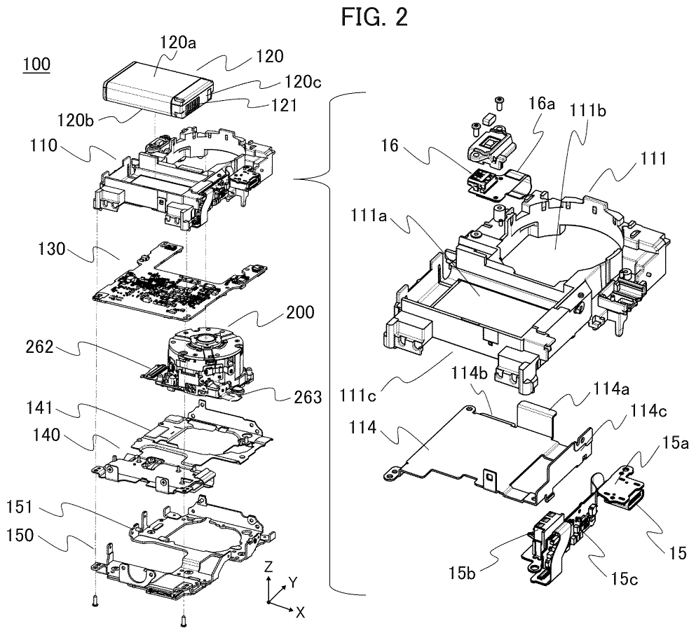

A configuration of a camera 1, which is an example of an imaging apparatus according to the present embodiment, will be explained with reference to FIGS. 1A to 1C and FIG. 2. The camera 1 is an imaging apparatus that includes a lens barrel 200. The camera 1 can capture both moving images and still images. First, a configuration of the exterior of the camera will be explained with reference to FIGS. 1A to 1C. FIGS. 1A to 1C are explanatory views of an external appearance of the camera. FIG. 1A is a front perspective view of the main body of the camera 1. FIG. 1B is a rear perspective view of the main body of the camera 1. FIG. 1C is a bottom view of the camera 1.

The Z-axis is an axis parallel to the optical axis of the lens barrel 200, which serves as the imaging optical axis of the camera 1, and the direction from the camera 1 toward a subject (not illustrated) is defined as the positive direction. The Y-axis is an axis that becomes parallel to the vertical direction when the Z-axis is set as parallel to the horizontal direction, and the direction toward the top is defined as the positive direction. The X-axis is an axis that is orthogonal to both the Y-axis and the Z-axis. As shown in FIG. 1A, the X-axis corresponds to the left-right direction of the camera 1, and the Y-axis corresponds to the up-down direction of the camera 1. Additionally, in the following explanation, the side of the direction along the positive Z-axis is referred to as the “front surface side,” and the side of the direction along the negative Z-axis is referred to as the “rear surface side.” The surface in the front side of the camera 1 is referred to as the “front surface,” the surface in the rear surface side is referred to as the “rear surface,” the surface in the side of the direction along the positive Y-axis is referred to as the “top surface,” the surface in the side of the direction along the negative Y-axis is referred to as the “bottom surface,” and the two surfaces in directions substantially orthogonal to the X-axis are referred to as the “side surfaces.”

The appearance of the front surface of the camera 1 is formed by a front cover 2. A front ring 3, which protrudes by one level in the positive Z-axis direction from the front cover 2 and is disposed on an outer periphery of the lens barrel 200, is provided on the front cover 2. A protective glass 4 is provided on the front ring 3. The protective glass 4 is a protective member that suppresses the adhesion of dirt, the occurrence of scratches, and the intrusion of dust on the lens that is located closest to the object side from among the lenses that are provided in the lens barrel 200.

Furthermore, a front surface grip region 5 is provided on the lower side (negative Y-axis direction side) of the front ring 3 for the user to hold the camera 1. Since the front surface ring portion 3 protrudes with respect to the front surface grip region 5, the user can naturally grip the front surface grip region 5, which is located below the front surface ring portion 3, when holding the camera 1. That is, the presence of the front ring portion 3 serves as a guide when the user holds the camera, and makes it possible to reduce the likelihood that the hand of the user will enter the imaging angle of view while holding the camera 1.

A start/stop button 6 and a front surface finger rest space 7 are provided within a front grip region 5. The start/stop button 6 is an operation member for controlling image capturing and is disposed on the upper portion (positive Y-axis side) of the front surface grip region 5. When the start/stop button 6 is pressed once by the user, the camera 1 starts image capturing, and when it is pressed again during this image capturing, the camera 1 stops the image capturing. The front surface finger rest space 7 is provided below the start/stop button 6 in the front grip region 5, and the user places a finger on the front surface finger rest space 7 when holding the camera 1.

The appearance of the top surface of the camera 1 is formed by a top surface cover 19. The top cover 19 is provided with microphone holes 20, which are disposed on the left and right sides of the upper portion of the lens barrel 200, and with speaker holes 21. The microphone holes 20 are holes for microphones and one microphone hole 20 is provided near each end of the top surface. That is, the microphone holes 20 are provided above the lens barrel 200. By providing the microphone holes 20 on the top surface of the camera 1, it becomes possible to reduce the difference in sound collection performance when collecting sounds coming from the front surface side and the rear surface side of the camera 1. The speaker holes 21 are holes for a speaker that reproduces operation sounds and audio of captured videos and are provided at a plurality of locations near the center of the top surface. Note that the speaker holes 21 may be a single hole.

The appearance of the rear surface of the camera 1 is formed by a rear cover 8. The rear cover 8 is provided with a display unit 9 and a rear surface operation member 10. The display unit 9 displays images and settings according to instructions from a processor of the camera 1. For example, when the power of the camera 1 is turned on and the camera is set to either a still image mode or a moving image mode, an image signal (through image) of a subject that is image captured by an imaging element (not illustrated) is displayed on the display unit 9. Additionally, the display unit 9 is connected to the camera body by a display unit hinge (not illustrated) and the display unit hinge has a rotation axis in the X direction with respect to the camera 1, so that an opening and closing operation of approximately 180° about the rotation axis is possible. As a result, the user, during self-photographing of himself or herself, can perform photographing while checking the composition on the display unit 9. Note that the display unit 9 may be a vari-angle monitor. The display unit 9 may also be a touch panel having a function as an operation section. By associating input coordinates with display coordinates on the touch panel, it is possible to construct a GUI that allows the user to operate the screen displayed on the touch panel as if directly operating it.

On the lower side of the display unit 9, a rear surface grip region 11 for the user to grip the camera 1 is provided at a position that is recessed by one level in the Z-axis direction relative to the display unit 9. Since the display unit 9 protrudes relative to the rear surface grip region 11, it naturally becomes easier for the user to hold the rear surface grip region 11, which is located below the display unit 9, when holding the camera 1. That is, the presence of a step between the display unit 9 and the rear surface grip region 11 serves as a guide when the user grips the camera 1 and helps prevent the hand of the user from overlapping with the display unit 9.

Within the rear grip region 11, a rear surface operation member 10 and a rear surface finger placement space 14 are provided. The rear surface operation member 10 includes a plurality of operation members such as a power button 12 and a playback button 13. The power button 12 is a button for turning the power of the camera 1 on and off. The playback button 13 is a button for instructing playback of recorded captured images. When the user operates the playback button 13, the captured images are displayed on the display unit 9. The rear surface operation member 10 is provided, for example, on the lower side of the rear surface grip region 11. A rear surface finger placement space 14 is a space for the thumb of the user when the user grips the camera 1. The rear surface finger placement space 14 is provided, for example, on the upper portion of the rear surface grip region 11 between the rear surface operation member 10 and the display unit 9. The rear surface finger placement space 14 is provided on the rear surface side of the start/stop button 6, and the front surface finger placement space 7 is provided on the front surface side of the rear surface operation member 10, so that the user can reliably operate the operation member while stably gripping the camera 1.

On the side face of the camera 1, a plurality of jacks and a stand 18 are provided. The appearance of the side surface of the camera 1 is formed by the front cover 2 and the rear cover 8. Jacks such as a USB terminal 15, an HDMI (trademark) terminal 16, and a microphone input terminal 17 are arranged at the Z-direction mating position between the front cover 2 and the rear cover 8 on the side surface of the camera 1. For example, the USB terminal 15 is provided on the side surface on the side of the positive X-axis, and the HDMI terminal 16 and the microphone input terminal 17 are provided on the side surface on the side of the negative X-axis. The USB terminal 15, the HDMI terminal 16, and the microphone input terminal 17 are arranged at positions above the front surface grip region 5 and the rear surface grip region 11. With this arrangement, it is possible to avoid interference between a cable inserted into a jack and the hand of the user gripping the camera 1, and to improve usability for the user.

The stand 18 is provided on the side surfaces of the front grip region 5 and the rear grip region 11. The stand 18 is connected to the body of the camera 1 via a stand hinge, and the stand hinge has the X-axis as its rotation axis, allowing the stand to be rotated about the axis. By using the stand 18, the camera 1 can be tilted about the X-axis, making it possible to perform fixed-position shooting at various angles. Additionally, in a state in which the stand 18 is stored in the camera 1, the stand 18 has the same side surface shape as the side surface shapes of the front cover 2 and the rear cover 8, and therefore, without causing a sense of incongruity in appearance, the stand 18 has a shape that does not interfere with gripping even in a usage state in which the user holds the camera 1.

On the bottom surface of the camera 1, a tripod mounting portion 22, a strap attachment portion 23, and a media cover 24 are provided. The tripod mounting portion 22 is a female threaded hole for attaching accessories such as a tripod. The strap attachment portion 23 is an attachment member for allowing a strap cord and the like to be passed through. The media cover 24 is a cover of a media unit into which a recording medium serving as external memory is loaded. The media cover 24 is attached to the body of the camera 1 in a manner that allows it to be opened and closed.

Next, the internal configuration of the camera will be explained with reference to FIGS. 1A to 1C. FIG. 2 is an explanatory view of the internal structure of the camera. The camera 1 includes an internal structure unit 100. The lens barrel 200, a battery 120, a main board 130, a rear surface heat sink unit 140, and a main chassis unit 150 are assembled to a main base unit 110.

The main base unit 110 includes a main base 111, an intermediate heat sink 114, the HDMI terminal 16, and a USB flexible cable 15a. The main base 111 is a component that serves as a foundation of the main base unit 110. The main base 111 is formed, for example, of a resin material. A battery chamber 111a and a barrel chamber 111b are formed in the main base 111.

The barrel chamber 111b is a space in which the lens barrel 200 is housed and held. On the outer periphery of the barrel chamber 111b, an HDMI terminal 16 for displaying video on an external display device and a USB terminal 15 for performing data transfer and power supply through connection with an external device are disposed. For example, the HDMI terminal 16 is disposed in the direction along the negative X-axis of the barrel chamber 111b, and the USB terminal 15 is disposed in the direction along the positive X-axis of the barrel chamber 111b. The HDMI terminal 112 is mounted on an HDMI flexible cable 112a and is connected to the main board 130.

The battery chamber 111a is a space in which the battery 120 is housed and held. The battery chamber 111a is provided in a region inside the camera 1 that corresponds to the front side grip region 5. Additionally, a cutout shape (not illustrated) is formed on a surface of the battery chamber 111a facing a second surface 120b, which is the thickness-direction surface of the battery 120, and the intermediate heat sink 114 is disposed so as to cover the cutout.

An explanation will now be given of the battery 120. The battery 120 has a shape close to a rectangular solid, and has a first surface 120a and the second surface 120b, which have the largest areas and are parallel to the XY plane. A third surface 120c that is orthogonal to the first surface 120a and to the second surface 120b is disposed in the camera 1 so as to be orthogonal to the X direction. A contact portion 121 for connection with battery terminals is provided on the third surface 120c. The main base 111 is provided with a battery terminal space (not illustrated) in which a battery terminal 15b is housed and held at a position facing the third surface 120c of the battery 120.

The intermediate heat sink 114 is a member that dissipates heat generated by the main board 130 and the like. The intermediate heat sink 114 has a first extension portion 114a and a second extension portion 114b, which are formed by being bent so as to extend in the optical axis direction between the battery chamber 111a and the lens barrel chamber 111b. The first extension portion 114a extends in the Z direction toward the front cover 2 side and is configured to allow thermal conduction with a front heat sink (not illustrated). Additionally, the second extension portion 114b extends toward the rear cover 8 side in the Z direction and is configured to allow thermal conduction with the main board 130. That is, heat from the main board 130 is conducted from the second extension portion 114b to the intermediate heat sink 114 and diffuses between the main board 130 and the battery 120. Furthermore, the intermediate heat sink 114 is configured to allow thermal conduction from the first extension portion 114a to the front heat sink. The intermediate heat sink 114 is formed, for example, of a sheet metal member. Since a sheet metal member can ensure rigidity even in a case in which its wall thickness is smaller than that of a resin member, it becomes possible to reduce the size of the battery chamber in the thickness direction while ensuring a shape for restricting the position of the battery. Additionally, the intermediate heat sink 114 is formed with a third extension portion 114c, which is parallel to the third surface 120c of the battery and is located on the battery chamber 111a in the direction along the positive X-axis thereof.

An explanation will now be given of the USB flexible cable 15a. The USB flexible cable 15a is provided with the USB terminal 15, the battery terminal 15b, and a power circuit region 15c. The USB terminal 15 is connected to the main board 130. The battery terminal 15b is electrically connected to the battery 120 via the contact portion 121. In the power circuit region 15c, components that are associated with the power circuit, such as a charging IC, are mounted. The power circuit region 15c is fixed so as to be in contact with the third extension portion 114c of the intermediate heat sink 114, and is configured to enable thermal diffusion of heat generated by the power circuit to the intermediate heat sink 114.

A tripod chamber 111c in which the tripod mounting portion 22 is housed is formed on the battery chamber 111a of the main base 111 in the negative Y-axis direction thereof. Screw seats (not illustrated) for screw-fixing the main board 130, the rear surface heat sink 141, and the main chassis 151 are formed on both sides of the tripod chamber 111c in the X-axis direction.

The main board 130 is provided with a central processing unit (CPU) and terminals for electrically connecting respective flexible boards. The main board 130 is fixed to the main base 111. The main board 130 is disposed so as to be orthogonal to the optical axis direction (Z-axis direction). The main board 130 is formed in a U-shape recessed at a space in which the lens barrel 200 is disposed, as viewed in the optical axis direction.

The lens barrel 200 is a barrel including an imaging optical system. The imaging optical system forms an optical image of a subject onto an imaging element. The lens barrel 200 is internally provided with a plurality of lenses that constitute an imaging optical system, a diaphragm mechanism that adjusts the amount of light that passes through the imaging optical system, and a focus mechanism that performs focus adjustment. The lens barrel 200 is, for example, a fixed focal length lens. That is, the lens barrel 200 is configured so as not to extend even when the user switches the power to the ON state (usage state). Additionally, the lens barrel 200 of the present embodiment is provided with an imaging element (not illustrated) that photoelectrically converts the optical image of a subject formed through the imaging optical system to generate image data. The imaging element is, for example, a sensor such as CMOS or CCD that performs photoelectric conversion and outputs an output signal corresponding to the optical image. Additionally, the lens barrel 200 includes a sensor flexible printed circuit board (FPC) 262 and a barrel FPC 263. The sensor FPC 262 connects the imaging element and the main board 130 and enables communication between them. The barrel FPC 263 connects the lens barrel 200 and the main board 130 and enables communication between them.

The rear surface heat sink unit 140 includes the rear surface heat sink 141, a wireless communication board (not illustrated), and a wireless FPC (not illustrated). The rear surface heat sink 141 diffuses heat generated by the imaging element (not illustrated) and the main board 130 to the entire rear surface of the camera 1. The rear surface heat sink 141 is disposed on the rear surface side of the lens barrel 200 and the main board 130 and disposed on the front surface side of the main chassis 151. The rear surface heat sink 141 is manufactured, for example, by press-forming a metal plate (such as aluminum or copper) having high thermal conductivity and high strength. The wireless communication board (not illustrated) has a function for wireless communication with external devices. Additionally, the wireless FPC (not illustrated) connects the wireless communication board and the main board 130, enabling mutual communication therebetween.

The main chassis unit 150 includes the main chassis 151 and a rear surface operation board (not illustrated). The main chassis unit 150 is disposed most toward the rear surface side of the camera 1 from among the internal structure units 100. The main chassis 151 is a structural member of the entire camera 1 and serves as the main ground (GND). The main chassis 151 is manufactured, for example, by press-working a metal plate. On a rear surface operation board (not illustrated), a switch for the rear surface operation member 10 is mounted.

An explanation will now be given of an assembly of the internal structure unit 100. The lens barrel 200 is incorporated into the barrel chamber 111b of the main base 111 after the main board 130 has been incorporated into the rear surface side of the main base 111, and the sensor FPC 262 and the barrel FPC 263 are connected to the terminals of the main board 130. Thereafter, the rear surface heat sink unit 140 and the main chassis unit 150 are assembled. At this time, the main board 130 is sandwiched by screw seats (not illustrated) that are provided on the main base 111 and screw-fixed, and furthermore, screw-fixed to the main base 111 at a plurality of locations around the lens barrel chamber 111b. In the present embodiment, the lens barrel 200 is clamped, via elastic members, between the main base 111, which serves as a first holding member, and the main chassis 151, which serves as a second holding member that is positioned on an opposite side to the main base 111 with the lens barrel 200 interposed between them in the optical axis direction. As a result, the configuration is such that vibrations that are caused by an actuator and the like in the lens barrel 200 are less likely to affect a microphone (not illustrated) that is disposed in the camera 1. That is, the camera 1 of the present embodiment has a clamping structure for the lens barrel 200.

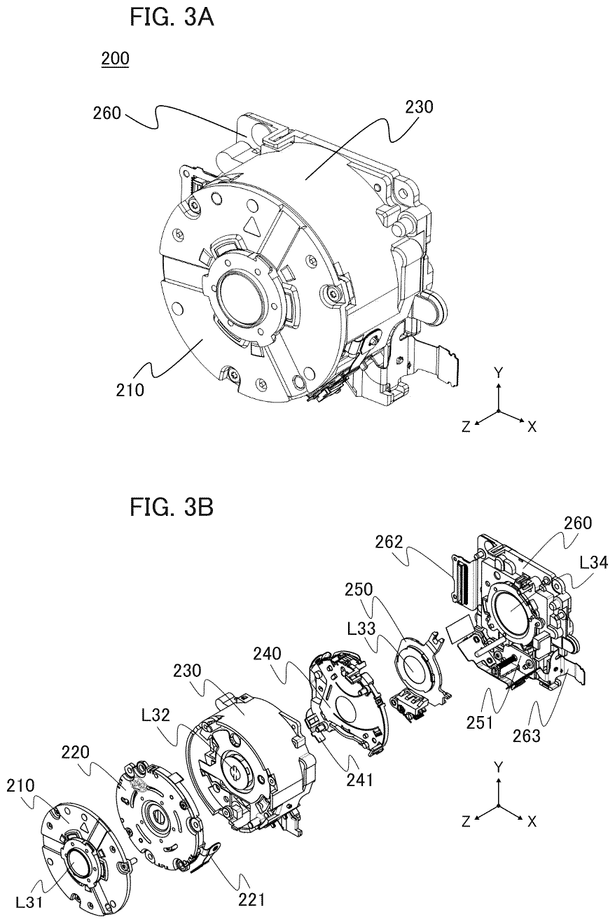

Next, the internal configuration of the lens barrel 200 will be explained with reference to FIGS. 3A and 3B. FIGS. 3A and 3B are explanatory views of the configuration of the lens barrel. FIG. 3A is a front surface perspective view of the lens barrel 200. FIG. 3B is an exploded perspective view of the lens barrel 200. The lens barrel 200 includes a first lens barrel 210, a diaphragm unit 220, a second lens barrel 230, an ND unit 240, a third lens barrel 250, and a sensor holder 260, in order from the front surface side of the camera 1. The lens barrel 200 also includes the sensor FPC 262 and the barrel FPC 263 that are connected to the sensor holder 260.

The first lens barrel 210 holds a first group lens L31. The first lens barrel 210 is provided on the front surface side of the camera 1. The diaphragm unit 220 is provided on the imaging element side of the first lens barrel 210 (rear surface side of the camera 1). The diaphragm unit 220 is a light amount adjustment unit that adjusts an amount of light that becomes incident on the first lens group L31 and is guided to an imaging element. The diaphragm unit 220 is a component that realizes a diaphragm mechanism. A diaphragm FPC 221 is provided in the diaphragm unit 220. The diaphragm FPC 221 is connected to the barrel FPC 263. The second lens barrel 230 is provided on the imaging element side of the diaphragm unit 220.

The second lens barrel 230 holds a second group lens L32. The ND unit 240 is mounted on the imaging element side of the second lens barrel 230. The ND unit 240 includes an ND filter (not illustrated). In the ND unit 240, an ND filter is opened and closed by a driving force of an ND drive unit (not illustrated), thereby adjusting an amount of light that becomes incident on the second lens group L32 and is guided to an imaging element (not illustrated). Additionally, an ND FPC 241 is provided in the ND unit 240. The ND unit 240 is connected to the barrel FPC 263. The third lens barrel 250 is provided on the imaging element side of the ND unit 240.

The third lens barrel 250 holds a third lens group L33 that constitutes a focus lens. The third lens barrel 250 is driven by a focus drive unit 251. The camera 1 performs a focusing operation by moving the position of the third group lens L33 in the optical axis direction by a drive force of the focus drive unit 251. The sensor holder 260 is provided on the imaging element side of the third lens barrel 250. The sensor holder 260 holds a fourth group lens L34 on the subject side and holds an imaging element (not illustrated) on the rear surface side of the camera 1. The sensor holder 260 is coupled to the second lens barrel 230 in the optical axis direction. Additionally, the sensor holder 260 is provided with the sensor FPC 262 and the barrel FPC 263. An imaging element and the main board 130 are connected to the sensor FPC 262. The aperture FPC 221 and the ND FPC 241 are terminal-connected to the lens barrel FPC 263 on an outer peripheral side of the sensor holder 260. Note that the center of the optical axis of the imaging optical system of the lens barrel 260 coincides with the imaging center of the imaging element.

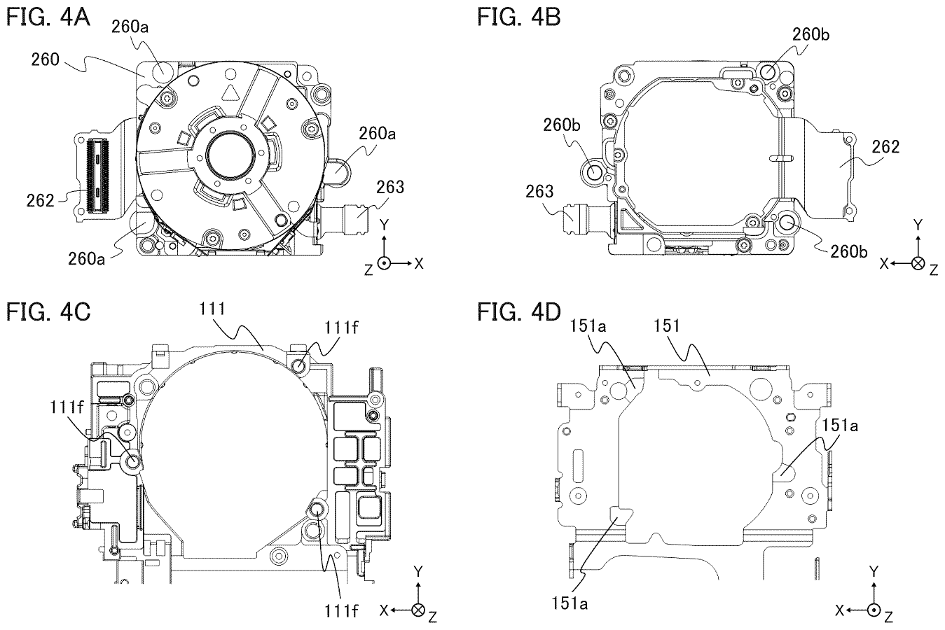

Next, the clamping structure of the lens barrel 200 will be explained with reference to FIGS. 4A to 4D to FIGS. 6A and 6B. FIGS. 4A to 4D are explanatory views of the structure related to the clamping structure of the lens barrel. FIG. 4A is a front surface view of the lens barrel 200. FIG. 4B is a rear surface view of the lens barrel 200. FIG. 4C is a rear surface view of the main base 111. FIG. 4D is a front surface view of the main chassis 151.

The lens barrel 200 is clamped between a main base 111, which is a first holding member, and a main chassis 151, which is a second holding member, via a plurality of elastic members for both the main base 111 and the main chassis 151. Each of the elastic members is, for example, sandwiched between a recessed housing portion and a flat contact portion. The housing portion is provided on a front surface side of the elastic member on a side to be assembled first, and the contact portion is provided on a rear surface side of the elastic member on a side to be assembled later. An elastic member is sandwiched between the housing portion that is provided on the main base 111 and the contact portion that is provided on the lens barrel 200, and an elastic member is sandwiched between a housing portion that is provided on the lens barrel 200 and the contact portion that is provided on the main chassis 151, thereby clamping the lens barrel 200. In the present embodiment, a case will be explained in which the lens barrel 200 is clamped between the main base 111 and the main chassis 151 via each of the three elastic members. Note that the elastic member may be a single member or two or more members may be disposed.

The sensor holder 260 of the lens barrel 200 is provided with three contact surfaces 260a for receiving first elastic members 160a, as shown in FIG. 4A. Additionally, as shown in FIG. 4B, the sensor holder 260 is provided with three housing portions 260b for housing second elastic members 160b. The contact surfaces 260a are provided on the front surface side of the sensor holder 260, and the housing portions 260b are provided on the rear surface side of the sensor holder 260. The three contact surfaces 260a are provided, for example, at an upper left portion, a lower left portion, and a vicinity of a right central portion of the sensor holder 260 in FIG. 4A, which is a view of the sensor holder 260 as viewed from a front surface side. The three housing portions 260b are provided, for example, at an upper right portion, a lower right portion, and a vicinity of a left central portion of the sensor holder 260 in FIG. 4B, which is a view of the sensor holder 260 as viewed from a rear surface side.

As shown in FIG. 4C, the main base 111 of the main base unit 110 is provided with three housing portions 111f for housing the first elastic members 160a. The three housing portions 111f are provided, for example, at an upper right portion, a lower right portion, and a vicinity of a left central portion of the main base unit 110 in FIG. 4C, which is a view of the main base unit 110 as viewed from the rear surface side. That is, the housing portions 111f of the main base unit 110 are respectively provided at positions corresponding to the contact surfaces 260a of the sensor holder 260, via first elastic members 160a.

As shown in FIG. 4D, the main chassis 151 is provided with three contact surfaces 151a for receiving the second elastic members 160b. The three contact surfaces 151a are provided, for example, at an upper left portion, a lower left portion, and around a right central portion of the sensor holder 260 in FIG. 4D, which is a view of the main chassis 151 as viewed from a front surface side. That is, the contact surfaces 151a of the main chassis 151 are respectively provided, via second elastic members 160b, at positions corresponding to the housing portions 260b of the sensor holder 260.

In the present embodiment, the shape of the elastic members 160 (elastic members 160a and 160b) is, for example, a substantially spherical shape such as a spherical body. Since the elastic member 160 has a substantially spherical shape, it becomes possible to perform assembly without the need to be concerned about the arrangement direction of the elastic member 160 during incorporation, and the case of assembly can be improved. The elastic member is manufactured, for example, by molding rubber such as NBR or IIR. Note that it is sufficient if the shape and material of the elastic member 160 are such that the lens barrel 200 can be clamped and held between the main base 111 side and the main chassis 151 side without tilting. For example, the shape of the elastic member may be a polyhedron, a cylindrical shape, or an elliptical shape, and may also be a single hollow O-ring.

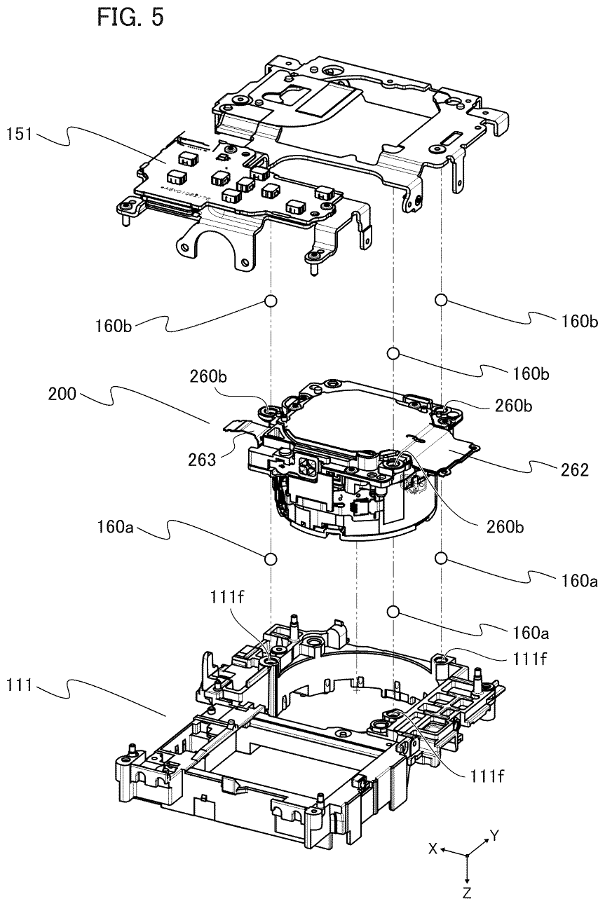

With reference to FIG. 5, a clamping structure for clamping the lens barrel 200 between the main base 111 and the main chassis 151 via the elastic member will be explained together with the assembly order. FIG. 5 is an explanatory view of the clamping structure of the lens barrel. Note that the explanation will be limited to components related to the clamping structure of the lens barrel 200. First, after the main board 130 is incorporated into the main base 111, a first elastic member 160a is incorporated into each of three housing portions 111f of the main base 111, and the lens barrel 200 is assembled into the lens barrel chamber 111b of the main base 111. As a result, the three first elastic members 160a are respectively held between the three accommodating portions 111f of the main base 111 and the three contact surfaces 260a of the lens barrel 200. The first elastic member 160a is pressed in the optical axis direction between the main base 111 and the lens barrel 200.

Thereafter, after a second elastic member 160b is incorporated into each of the three housing portions 260b of the sensor holder 260, the rear surface heat sink unit 140 and the main chassis unit 150 are assembled. As a result, the three second elastic members 160b are respectively held between the three housing portions 260b of the sensor holder 260 and the three contact surfaces 151a of the main chassis 151. The second elastic member 160b is pressed in the optical axis direction between the sensor holder 260 of the lens barrel 200 and the main chassis 151. Then, the main board 130 is screw-fixed by being clamped at screw seats (not illustrated) that are provided on the main base 111, and further, the main base 111 is screw-fixed at a plurality of locations around the lens barrel chamber 111b.

In assembling from the main base 111 to the main chassis 151, the other components are sequentially incorporated in the positive Z-axis direction (subject side), using the main base 111 as the assembly reference component. The assembly is performed while lowering the main base 111 such that the front surface of the main base 111 comes into contact with an assembly jig (not illustrated), in such a manner that the first elastic member 160a, the lens barrel 200, the second elastic member 160b, and finally the main chassis 151 are sequentially assembled in an overlapping manner.

Since the elastic member 160a is assembled into the housing portion 111f provided in the main base 111, and the elastic member 160b is assembled into the housing portion 260b provided in the lens barrel 200, it is preferable that the housing portion 111f and the housing portion 260b be of a concave shape. By forming the housing portion 111f and the housing portion 260b in a concave shape and forming the elastic member 160 in a substantially spherical shape, the arrangement of the elastic member 160 is completed simply by dropping the elastic member 160 into the concave shape of each of the housing portions. Additionally, since the elastic member 160 has a spherical shape, it is possible to perform the assembly without the need to be concerned about the orientation of the elastic member 160 during incorporation. In this manner, by forming each housing portion into which the elastic member 160 is to be incorporated in a concave shape and by forming the elastic member 160 in a substantially spherical shape, it is possible to enhance the case of assembly thereof.

Note that, although in the present embodiment, the contact surface 260a of the lens barrel 200 that opposes the housing portion 111f of the main base 111 and the contact surface 151a of the main chassis 151 that opposes the housing portion 260b of the lens barrel 200 are respectively flat surfaces, the present disclosure is not limited thereto. For example, the shape of the contact surface 260a and the shape of the contact surface 151a may each be a concave shape. Additionally, although it is desirable that the concave shapes of the three housing portions 111f of the main base 111 and the three housing portions 260b of the sensor holder 260 be all of the same shape, the present disclosure is not limited thereto. Additionally, it is desirable that the housing portions 111f and the housing portions 260b be provided in the same number, for example, three each.

The lens barrel 200 is clamped and held between the main base 111 and the main chassis 151 via a plurality of elastic members 160. Accordingly, if a difference arises in the elastic forces of the six elastic members 160 that are arranged on both the front and rear of the lens barrel 200, the lens barrel 200 may tilt with respect to the main base 111 or the main chassis 151. If the lens barrel 200 tilts due to a difference in elastic force, there is a risk that the lens barrel 200 will become eccentric with respect to the front cover 2, resulting in a degraded appearance, that the lens barrel 200 will interfere with other components inside the camera, or that the optical performance of the lens barrel 200 will deteriorate. Therefore, it is desirable that the elastic forces be equal for all of the six elastic members 160, which are arranged on the three housing portions 111f on the main base 111 side and on the three housing portions 260b on the main chassis 151 side with respect to the lens barrel 200. In order to equalize the elastic force of each elastic member 160, it is desirable that the first elastic members 160a and the second elastic members 160b be provided in equal numbers. Additionally, it is desirable that the shapes of all of the elastic members 160 that are arranged in the housing portions 111f and the housing portions 260b be the same, and that the materials thereof also be the same. Additionally, it is desirable that the housing portions 111f of the main base 111 and the housing portions 260b of the sensor holder 260 be provided in the same number, and that each housing portion have the same shape.

Furthermore, it is desirable that the three housing portions 111f of the main base 111 and the three housing portions 260b of the sensor holder 260 respectively have the same positions in the XY plane. Note that, as long as the center-of-gravity position in the XY plane of the three housing portions 111f of the main base 111 and the center-of-gravity position in the XY plane of the three housing portions 260b of the sensor holder 260 are the same, the positions of the housing portions 111f and the housing portions 260b in the XY plane are not required to be the same.

Additionally, in the present embodiment, although three elastic members 160 are provided on each of the main base 111 side and the main chassis 151 side with respect to the lens barrel 200, the present disclosure is not limited thereto. For example, four first elastic members 160a may be provided on the main base 111 side, and four second elastic members 160b may be provided on the main chassis 151 side. Furthermore, as long as the resultant force of the elastic forces of the first elastic members 160a that are disposed on the main base 111 side is equal to the resultant force of the clastic forces of the second elastic members 160b that are disposed on the main chassis 151 side, the numbers of the elastic members 160 that are disposed on each side do not need to be the same. For example, three first elastic members 160a may be provided on the main base 111 side, and four second elastic members 160b may be provided on the main chassis 151 side. As explained above, it is sufficient if the configuration is such that the lens barrel 200 is clamped and held without tilting with respect to the main base 111 side and the main chassis 151 side, and the shape, number, and position of the elastic members 160 and the housing portions 111f are not limited.

After the first elastic member 160a, the lens barrel 200, the second elastic member 160b, and the main chassis 151 are assembled in a stacked manner on the main base 111, the main chassis 151 is screw-fixed to the main base 111 at a plurality of locations around the lens barrel chamber 111b. Consequently, the lens barrel 200 is clamped and held between the main base 111 and the main chassis 151 via the clastic members 160.

Next, an explanation will be given of the elastic force of the elastic members 160. As the elastic force of the elastic member 160 with respect to the lens barrel 200 becomes lower, vibration generated in the lens barrel 200 becomes less likely to affect a microphone (not illustrated) disposed in the camera 1. On the other hand, as the elastic force of the elastic member 160 with respect to the lens barrel 200 becomes higher, vibration generated in the lens barrel 200 becomes more likely to propagate to a microphone (not illustrated) disposed in the camera 1. Therefore, for reduction of the propagation of vibration generated in the lens barrel 200 to a microphone (not illustrated) disposed in the camera 1, it is desirable that the clastic force of the elastic member 160 be small.

On the other hand, the lens barrel 200 is retained solely by being clamped between the main base 111 and the main chassis 151 via the elastic members 160. Therefore, when the camera body 1 receives an external impact or is dropped, the lens barrel 200 may move against the elastic forces of the elastic members 160. Therefore, in order to reduce the likelihood that the lens barrel 200 moves in response to external impacts, it is desirable that the elastic forces of the elastic members 160 be high. Therefore, the elastic force of the elastic member 160 needs to be determined by comprehensively taking into account both the influence on the microphone of the vibration generated in the lens barrel 200 and the influence of external impacts and the like.

In order to set the elastic member 160 to an appropriate elastic force, it is necessary to compress the elastic member 160 with an appropriate amount of deflection (charge amount). When the main chassis 151 is screw-fixed to the main base 111 at a plurality of locations around the barrel chamber 111b, the deflection amount of the elastic members 160 can be controlled by managing the height of the main chassis 151 using a jig (not illustrated). Therefore, it is necessary to assemble the main chassis 151 at a height that provides an amount of deflection of the elastic members 160 that achieves both a reduction in the propagation of vibration generated in the lens barrel 200 and resistance to external impacts. Additionally, to set an appropriate clastic force, it is also possible to change the elastic force by varying the size or hardness of the elastic member 160, in addition to varying the amount of deflection of the elastic member 160.

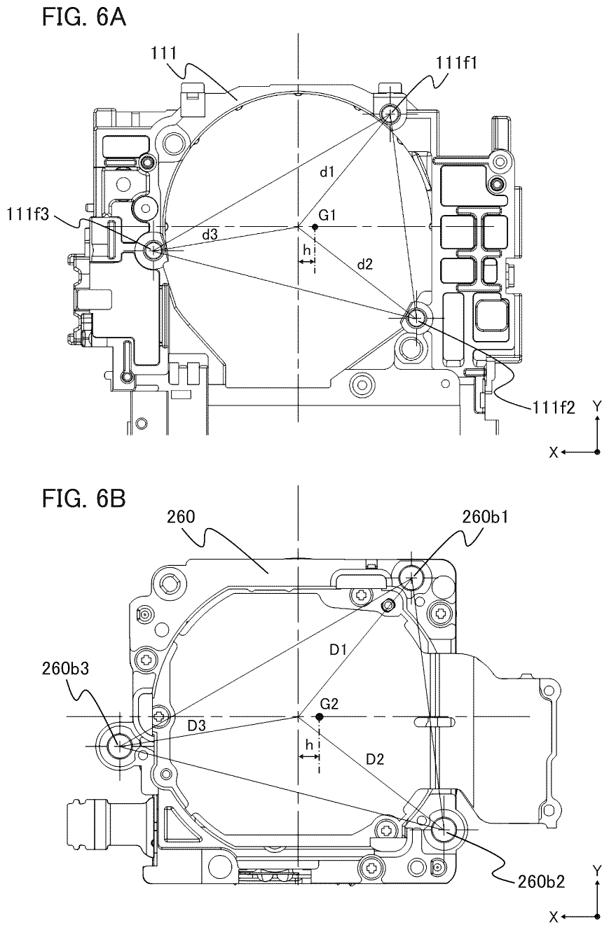

Next, with reference to FIGS. 6A and 6B, the positional relation between the lens barrel 200 and the housing portion 111f, and between the lens barrel 200 and the housing portion 260b will be explained. FIGS. 6A and 6B are sectional views of a main part showing a configuration of a clamping structure of the lens barrel 200. FIG. 6A is a rear view illustrating the positional relation of housing portions 111f of the main base 111. FIG. 6B is a rear view showing the positional relation of the housing portions 260b of the sensor holder 260.

As shown in FIG. 6A, the elastic members 160a are disposed in three housing portions 111f (111f1, 111f2, and 111f3) in an XY plane. Similarly, as shown in FIG. 6B, the elastic members 160b are disposed in three housing portions 260b (260b1, 260b2, and 260b3) in the XY plane. Here, the centroid position of a polygon formed by connecting the center positions of the housing portions 111f of the main base 111 is defined as a centroid position G1, and the centroid position of a polygon formed by connecting the center positions of the housing portions 260b of the lens barrel 200 is defined as a centroid position G2. In the present embodiment, the centroid position of the three housing portions 111f of the main base 111 is defined as the centroid position G1, and the centroid position of the three housing portions 260b of the lens barrel 200 is defined as the centroid position G2. As described above, it is desirable that the positions of G1 and G2 in the XY plane be the same. Then, it is desirable that the centroid position G1 and the centroid position G2 substantially coincide with the optical axis center of the lens barrel 200.

A front ring 3 provided with protective glass 4 is provided on the front surface of the camera 1. The protective glass 4 is a component that prevents a lens L31, which is located at the foremost position of the lens barrel 200, from being touched by a hand and thereby becoming dirty, and that also prevents scratches and intrusion of dust. If the optical axis center position of the protective glass 4 and the optical axis center of the lens barrel 200 are decentered, there is a concern that the optical characteristics may deteriorate, for example, due to the occurrence of asymmetric blur or coma aberration, and a decrease in peripheral light quantity. Even if the lens barrel 200 tilts in a state in which the centroid position G1, the centroid position G2, and the optical axis center of the lens barrel 200 coincide with each other, the optical axis center position of the protective glass 4 and the imaging center position are not decentered. However, if the lens barrel 200 tilts about the centroid position G1 and the centroid position G2 in a state in which the centroid position G1, the centroid position G2, and the optical axis center position of the protective glass 4 are decentered, the optical axis center position of the protective glass 4 and the optical axis center position of the lens barrel 200 become decentered. As a result, the optical characteristics of the lens barrel 200 are degraded. An increase in the decentering amount h between the centroid position G1, the centroid position G2, and an optical axis center of the lens barrel 200 increases the decentering amount Δh in the XY direction of the centroid position G1 and the centroid position G2 when the lens barrel 200 tilts, thereby causing greater degradation of optical characteristics. On the other hand, when the centroid position G1, the centroid position G2, and an optical axis center of the lens barrel 200 coincide with each other, that is, when the decentering amount h of the optical axis center is 0, the decentering amount Δh in the XY direction of the centroid position G1 and the centroid position G2 is also 0, and theoretically, the optical characteristics are not degraded. For this reason, it is desirable that, in the XY plane, a centroid position G1 of a polygon formed by connecting the positions of the housing portions 111f and a centroid position G2 of a polygon formed by connecting the center positions of the housing portions 260b substantially coincide with an optical axis center of the lens barrel 200.

Next, the positional relation between the housing portions 111f of the main base 111, the housing portions 260b of the sensor holder 260, and the optical axis center of the lens barrel 200 will be explained. As shown in FIG. 6A, the three housing portions 111f of the main base 111 are respectively referred to as housing portions 111f1, 111f2, and 111f3. Additionally, each of the distances from the housing portions 111f1, 111f2, and 111f3 to an optical axis center of the lens barrel 200 are defined as d1, d2, and d3. It is desirable that the distances between each of the housing portions of the main base 111 and an optical axis center of the lens barrel 200 satisfy the relation d1=d2 =d3.

As shown in FIG. 6B, each of the three housing portions 260b of the lens barrel 260 are referred to as housing portion 260b1, housing portion 260b2, and housing portion 260b3. Additionally, each of the distances from the housing portion 260b1, the housing portion 260b2, and the housing portion 260b3 to an optical axis center of the lens barrel 200 are defined as D1, D2, and D3. It is desirable that the distances between each of the housing portions 260b of the sensor holder 260 and an optical axis center of the lens barrel 200 satisfy the relation D1=D2=D3.

Then, assuming that an optical axis center of the lens barrel 200 serves as a center of rotation, a distance from each housing portion to the optical axis center position of the lens barrel 200 is d, and an elastic force of the elastic member 160 is F, a moment N generated in each housing portion is given by N=d×F. In order to prevent the lens barrel 200 from tilting with respect to the main base 111 and the main chassis 151, the elastic forces of the elastic members 160 of the six housing portions are adjusted so as to be equal, as explained above. Furthermore, the moments N generated in the three housing portions on the front side and the three housing portions on the rear side, with the lens barrel 200 interposed therebetween, are set to be balanced with each other. If d1=d2=d3 and D1=D2=D3, the d components of the moments are all the same, thereby reducing differences in the moments that are generated in the respective housing portions and, as a result, reducing the tilting of the lens barrel 200. That is, it is desirable that respective distances from an optical axis center of the lens barrel 200 to center positions of the respective housing portions 111f of the main base 111 and to center positions of the three housing portions 260b of the lens barrel 260 are substantially equal. Thus, each housing portion is formed at a position that meets the above-described conditions. It should be noted that since the positions of the three housing portions 111f on the main base 111 side coincide in the XY plane with positions of the housing portions 260b on the sensor holder 260 side, the explanation of the positional relation between the housing portions 111f of the main base 111 and the optical axis center will be omitted.

Although, in the present embodiment, an example has been described in which the housing portions 111f are formed in the main base 111 and the housing portions 260b are formed in the sensor holder 260 of the lens barrel 200, the present disclosure is not limited thereto. A housing portion for accommodating the first elastic member 160a only needs to be formed in at least one of the sensor holder 260 of the lens barrel 200 and the main base 111. Additionally, a housing portion for accommodating the second elastic member 160b only needs to be formed in either the sensor holder 260 of the lens barrel 200 or the main chassis 151. In this case, each housing portion is formed such that the direction in which the first elastic member 160a and the second elastic member 160b are incorporated is the same.

As explained above, according to the present embodiment, it is possible to support the lens barrel by clamping it via the elastic members. As a result, it becomes possible to facilitate assembly and to reduce propagation of vibration generated in the lens barrel to a microphone and the like.

### Other Embodiments

The present disclosure can also be realized by a process in which a program that realizes one or more functions of the above-described embodiment is supplied to a system or apparatus via a network or a storage medium, and one or more processors in a computer of the system or apparatus read and execute the program. Additionally, the disclosure may also be realized by a circuit (for example, an ASIC) that realizes one or more functions.

Although the preferred embodiments of the present disclosure have been explained above, the present disclosure is not limited to these embodiments, and various modifications and changes can be made without departing from the spirit and scope of the disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to provide an imaging apparatus that is easy to assemble and capable of reducing the propagation of vibrations that are generated in the lens barrel.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An imaging apparatus comprising:
a lens barrel;
a first holding member that holds the lens barrel via a first elastic member;
a second holding member that holds the lens barrel via a second elastic member;
the first elastic member disposed between the lens barrel and the first holding member; and
the second elastic member disposed between the lens barrel and the second holding member,
wherein the second holding member is disposed, in an optical axis direction, on an opposite side to the first holding member with the lens barrel interposed therebetween, and
wherein the lens barrel is clamped by the first holding member and the second holding member via the first elastic member and the second elastic member.

2. The imaging apparatus according to claim 1,
wherein the first elastic member is compressed in an optical axis direction between the lens barrel and the first holding member, and
wherein the second elastic member is compressed in the optical axis direction between the lens barrel and the second holding member.

3. The imaging apparatus according to claim 1,
wherein a first housing portion that incorporates and houses the first elastic member is formed in one of the lens barrel and the first holding member, and
wherein a second housing portion that incorporates and houses the second elastic member is formed in one of the lens barrel and the second holding member.

4. The imaging apparatus according to claim 3,
wherein two or more of the first elastic members and two or more of the second elastic members are disposed,
wherein a number of the first housing portions is equal to a number of the first elastic members, and each of the first housing portions houses one of the first elastic members, and
wherein a number of the second housing portions is equal to a number of the second elastic members, and each of the second housing portions houses one of the second elastic members.

5. The imaging apparatus according to claim 3,
wherein the first housing portion and the second housing portion are formed such that a direction in which the first elastic member is incorporated into the first housing portion and a direction in which the second elastic member is incorporated into the second housing portion are the same.

6. The imaging apparatus according to claim 3,
wherein, in a case in which the first holding member is disposed on a subject side in the optical axis direction and the second holding member is disposed on an imaging element side in the optical axis direction, the first housing portion is formed in the first holding member and the second housing portion is formed in the lens barrel.

7. The imaging apparatus according to claim 3,
wherein the same number of the first housing portions and the second housing portions are provided.

8. The imaging apparatus according to claim 3,
wherein a centroid position of a polygon formed by connecting center positions of the plurality of first housing portions substantially coincides with an optical axis center of the lens barrel in a plane orthogonal to the optical axis, and
wherein a centroid position of a polygon formed by connecting center positions of the plurality of second housing portions substantially coincides with the optical axis center of the lens barrel in a plane orthogonal to the optical axis.

9. The imaging apparatus according to claim 3,
wherein respective distances from a center of an optical axis of the lens barrel to center positions of the plurality of the first housing portions and the plurality of the second housing portions substantially coincide.

10. The imaging apparatus according to claim 3,
wherein positions of the plurality of first housing portions and positions of the plurality of second housing portions substantially coincide in a plane orthogonal to an optical axis.

11. The imaging apparatus according to claim 1,
wherein the same number of the first elastic members and the second elastic members are provided.
